(19) United States
(12) Patent Application Publication
(10) Pub. No.: US 2026/0336709 A1
(43) Pub. Date: Oct. 29, 2026

(54) BODY OF VEHICLE

(71) Applicants: Hyundai Motor Company, Seoul (KR); Kia Corporation, Seoul (KR)

(72) Inventor: Seung Min JEONG, Hwaseong-Si (KR)

(21) Appl. No.: 19/396,919

(22) Filed: Nov. 21, 2025

(30) Foreign Application Priority Data
Apr. 28, 2025 (KR) 10-2025-0055548

(51) Int. Cl. B62D 25/02

(52) U.S. Cl. CPC B62D 25/025

(57) ABSTRACT

A body of a vehicle is disclosed. The vehicle body may include: a rear suspension that includes a pair of trailing arms, and an axle beam connecting, in a lateral direction of the vehicle, the trailing arms; a rear side portion having a first end connected to a center side portion of the vehicle body and a second end connected to one of the pair of trailing arms; a side sill provided on side surfaces of the center side portion and the rear side portion; and a support bracket connecting the side sill to the second end of the rear side portion.

### CROSS-REFERENCE TO RELATED APPLICATION

This application claims priority to and the benefit of Korean Patent Application No. 10-2025-0055548, filed Apr. 28, 2025, in the Korean Intellectual Property Office, the disclosure of which is incorporated herein by reference in its entirety.

### TECHNICAL FIELD

The present disclosure relates to a body of a vehicle.

### BACKGROUND

With the advancement of technology related to electric vehicles and autonomous driving, purpose-built vehicles (PBVs) may satisfy various usability requirements. In such a purpose-built vehicle, the size of the interior space thereof may be linked to enhancing the marketability of the vehicle because the interior space may need to meet the various usability requirements of desired use cases. In order to satisfy such an interior space requirement in the purpose-built vehicle, a low floor height and sliding doors may be implemented.

The above matters disclosed in this section are merely for enhancement of understanding of the general background of the disclosure and should not be taken as an acknowledgement or any form of suggestion that the matters form the related art already known to a person skilled in the art.

### SUMMARY

To achieve a low floor height in the vehicle, a trailing arm is configured to be inserted into a rear side member, thereby causing the cross-section of the rear side member to be locally weak. Consequently, there is a need to secure rigidity to withstand rear collisions of the vehicle and to enhance collision performance.

Aspects of the present disclosure are not limited to the above-described aspect, and other aspects of the present disclosure not yet described will be more clearly understood by those skilled in the art from the following detailed description.

According to one or more example embodiments of the present disclosure, a vehicle body of a vehicle may include: a rear suspension that includes a pair of trailing arms, and an axle beam connecting, in a lateral direction of the vehicle, the trailing arms; a rear side portion having a first end connected to a center side portion of the vehicle body and a second end connected to one of the pair of trailing arms; a side sill provided on side surfaces of the center side portion and the rear side portion; and a support bracket connecting the side sill to the second end of the rear side portion.

An outer surface of the side sill may be opened to form an open space. The vehicle body may further include a connection bracket provided at the open space of the side sill and connected, via the side sill, to the support bracket.

The side sill may include a B-pillar region and a C-pillar region. The support bracket may connect the C-pillar region of the side sill to the second end of the rear side portion.

The rear side portion may include a pair of rear side portions that are spaced apart from each other in the lateral direction of the vehicle, The vehicle body may further include: a rear cross portion extending in the lateral direction of the vehicle and configured to connect the pair of rear side portions.

A battery may be coupled to the rear cross portion in the lateral direction of the vehicle.

The vehicle body may further include: a door rail provided at an upper end of the side sill; a sliding arm slidably coupled to the door rail; and a sliding door coupled to the sliding arm.

A first end of the door rail may be disposed inside the center side portion.

The door rail may include: a lower rail support formed on an upper surface of the side sill and a door housing. The door housing may include: an upper door housing; and a lower door housing provided at the center side portion. An upper rail guide, which faces the lower rail support, may be formed in a lower portion of the upper door housing.

The lower rail support may form, with the upper surface of the side sill, a closed cross-section.

The center side portion may be shaped to have an open upper surface. An open portion that is opened outwards may be formed on a side surface of a middle portion of the center side portion. The lower door housing may be coupled to the center side portion by inserting through the open portion of the center side portion.

The vehicle body may further include: a center floor that includes the center side portion, a center cross portion, and a center plate. The center plate may be provided on upper surfaces of the center side portion and the center cross portion. The upper door housing may be coplanar with the center plate.

A first end of the lower rail support and a first end of the upper rail guide may be disposed inside the lower door housing.

The rear side portion may increase in width as the rear side portion extends from the first end of the rear side portion to the second end of the rear side portion. The rear side portion may decrease in width as the rear side portion further extends from the second end of the rear side portion to a third end of the rear side portion.

The rear side portion may bend upwards as the rear side portion extends from the second end of the rear side portion to the third end of the rear side portion.

The rear suspension may further include a damper and a suspension. The damper and the suspension may be coupled to the third end of the rear side portion.

According to one or more example embodiments of the present disclosure, a vehicle body of a vehicle may include: a center frame; a rear frame that includes a front portion connected to the center frame, a middle portion connected to a rear suspension trailing arm of the vehicle, and a rear portion; a side sill provided along the center frame and the rear frame; and a support bracket connecting the side sill to the middle portion of the rear frame.

The vehicle body may further include: a door rail support provided on the side sill; and a door housing that includes a door rail guide. The door rail guide may be disposed to face the door rail support.

The vehicle body may further include: a floor that includes the center frame, a center cross beam, and a center plate.

The rear frame may increase in width as the rear frame extends from the front portion to the middle portion and decrease in width as the rear frame extends from the middle portion to the rear portion.

The rear frame may bend upward as the rear frame extends from the middle portion to the rear portion.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a lateral perspective view of a body of an example vehicle;

FIG. 2 shows an enlarged view of a C-pillar region of a side sill in an example vehicle;

FIG. 3 shows connections among the side sill, a support bracket, and a rear side member in an example vehicle;

FIG. 4 is a bottom view of a portion of an example vehicle body;

FIG. 5 is a lateral perspective view of the side sill and other components of an example vehicle;

FIG. 6 shows an enlarged view of a B-pillar region of the side sill in an example vehicle;

FIG. 7 shows a lateral cross-section taken along line A-A in FIG. 4;

FIG. 8 shows a bottom portion of an example vehicle body;

FIG. 9 shows a side sill, a door rail, and a center side member of an example vehicle; and

FIG. 10 shows a center side member of an example vehicle.

### DETAILED DESCRIPTION

In the following description of one or more example embodiments of the present disclosure, a detailed description of known technologies incorporated herein will be omitted when it may obscure the subject matter of the present disclosure. In addition, the example embodiment(s) of the present disclosure will be more clearly understood from the accompanying drawings and should not be limited by the accompanying drawings, and it is to be appreciated that all changes, equivalents, and substitutes that do not depart from the spirit and technical scope of the present disclosure are encompassed in the present disclosure. The following description is not intended to limit the present disclosure to the precise forms or particular fields of use disclosed. As such, it is contemplated that various alternate embodiment(s) and/or modification(s) to the present disclosure, whether explicitly described or implied herein, are possible in light of the disclosure. A person of ordinary skill in the art will recognize that changes may be made in form and detail without departing from the scope of the present disclosure.

The present disclosure will be described with reference to one or more example embodiments. However, as one skilled in the art will appreciate, various example embodiment(s) disclosed herein may be modified or otherwise implemented in various other ways without departing from the spirit and scope of the disclosure. Accordingly, the following description is to be considered as illustrative and is for the purpose of teaching those skilled in the art the manner of making and using various example embodiment(s). It is to be understood that the forms of disclosure shown and described herein are to be taken as representative example embodiment(s). Equivalent elements, materials, processes, or steps may be substituted for those representatively illustrated and described herein. Expressions, such as “including,” “comprising,” “incorporating,” “consisting of,” “have,” and “is,” that are used to describe the present disclosure are intended to be construed in a non-exclusive manner, namely, in a manner allowing items, components or elements not explicitly described to be present. Unless clearly used otherwise, singular expressions should be interpreted as including a plural meaning.

For purposes of the present application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as "A, B, or C", "at least one of A, B, and C", "at least one of A, B, or C", etc. as used herein may mean each listed item or all possible combinations of the listed items. For example, "at least one of A or B" may refer to (1) at least one A; (2) at least one B; or (3) at least one A and at least one B.

Furthermore, various example embodiment(s) disclosed herein are to be taken in the illustrative and explanatory sense, and should in no way be construed as limitative of the present disclosure. All references as to joining (e.g., attached, affixed, coupled, connected, and the like) are only used to aid understanding of the present disclosure, and may not create limitations, particularly as to the position, orientation, or use of the configuration or the method disclosed herein. Therefore, references as to joining, if any, are to be construed broadly. Moreover, such references as to joining do not necessarily indicate that two elements are directly connected to each other. Additionally, all numerical terms, such as, but not limited to, “first”, “second”, “third”, “primary”, “secondary”, “main” or any other ordinal or numerical terms, should also be taken only as identifiers to assist understanding of various element(s), example embodiment(s), variation(s) or modification(s) of the present disclosure, and may not mean any limitation as to the present disclosure, variation or modification of any element or any limitation as to the order or preference thereof. That is, although such expressions may be used to describe various constituent elements, these constituent elements are not limited by the expressions associated therewith. Such expression is used only for distinguishment of one constituent element from another constituent element.

The suffixes “module” and “unit” of elements herein are used for convenience of description and thus may be used interchangeably and do not have any distinguishable meanings or functions.

In the case where an element is "connected" or "linked" to another element, it should be understood that the element may be directly connected or linked to the other element, or another element may be present therebetween. Conversely, in the case where an element is "directly connected" or "directly linked" to another element, it should be understood that no other element is present therebetween.

Any number of components or a variety of components of any one of the configurations disclosed in the present disclosure may be included in the present disclosure. Such components may include any combination of characterized parts disclosed in the present disclosure, and may be arranged to constitute any one of various configurations disclosed in the present disclosure. Not only structures and arrangements of the components of the present disclosure, but also concepts as to use and operation thereof, may be applied not only to particular example embodiment(s) discussed in the present disclosure, but also to example embodiment(s) of any numbers and in any combinations. In the following description, example embodiment(s) including various characterized parts having various arrangements will be described with reference to the accompanying drawings.

Hereinafter, one or more example embodiments disclosed in the present disclosure will be described in detail with reference to the accompanying drawings, and the same or similar elements are designated by the same reference numerals regardless of the numerals in the drawings and redundant description thereof will be omitted.

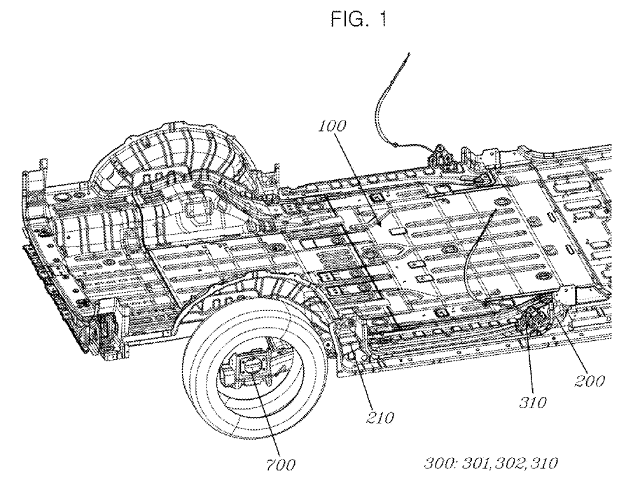

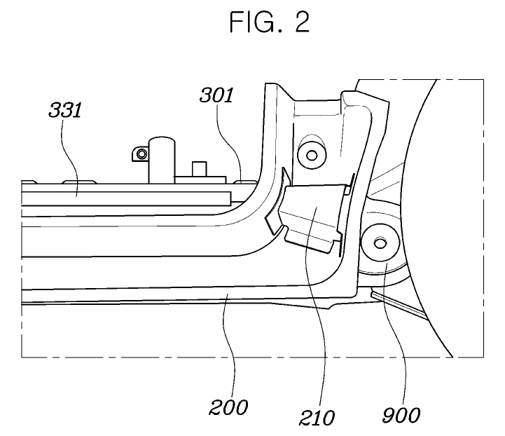

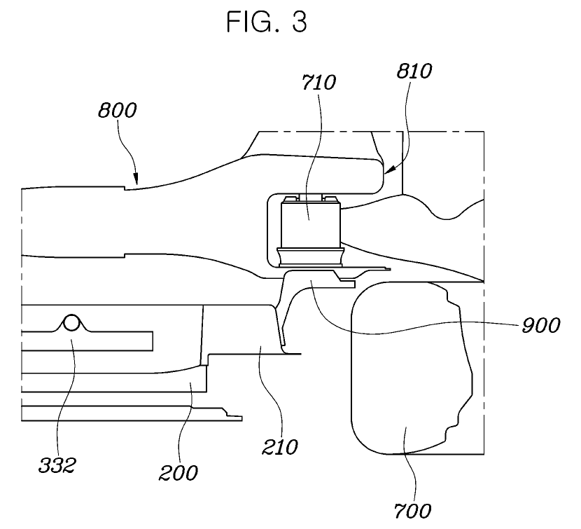

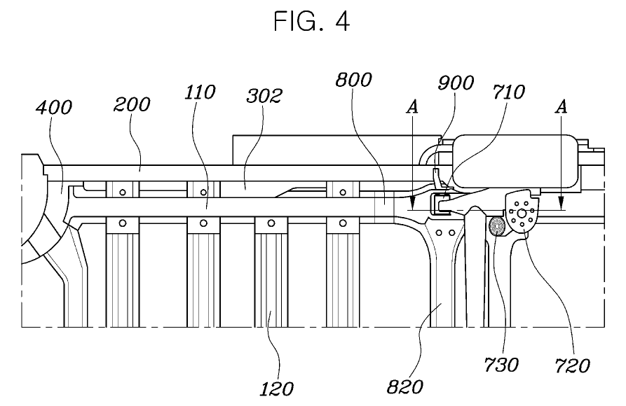

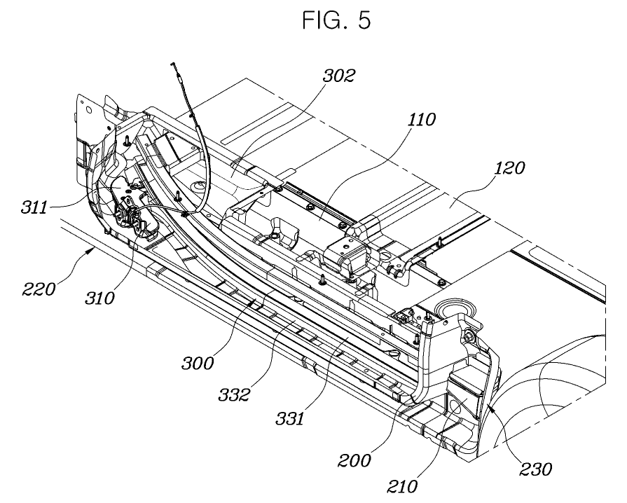

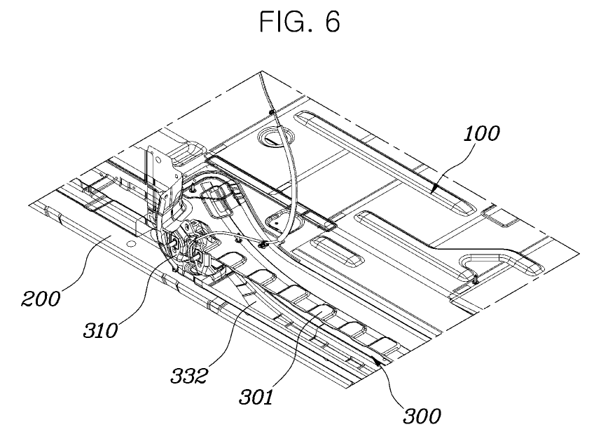

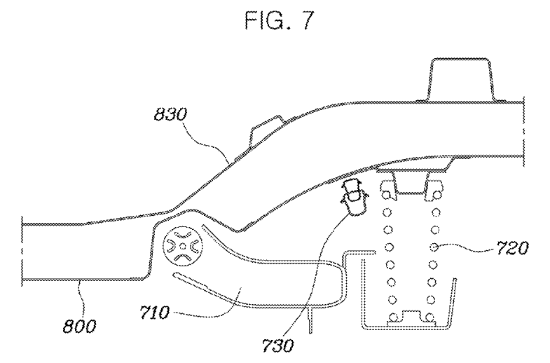

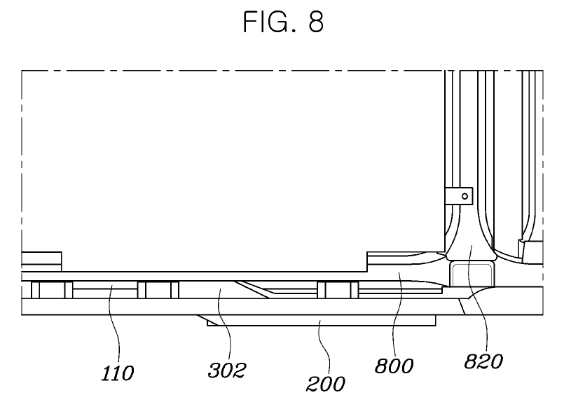

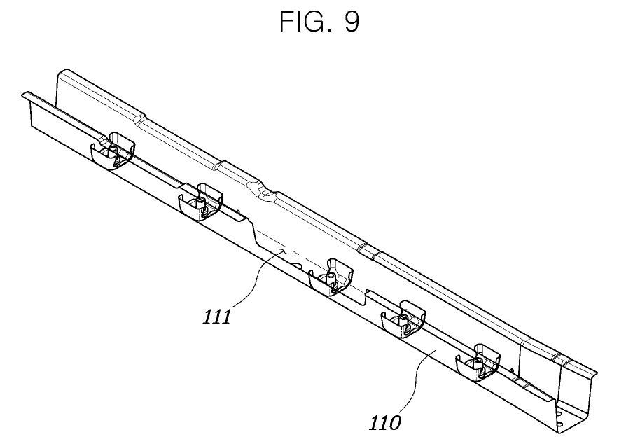

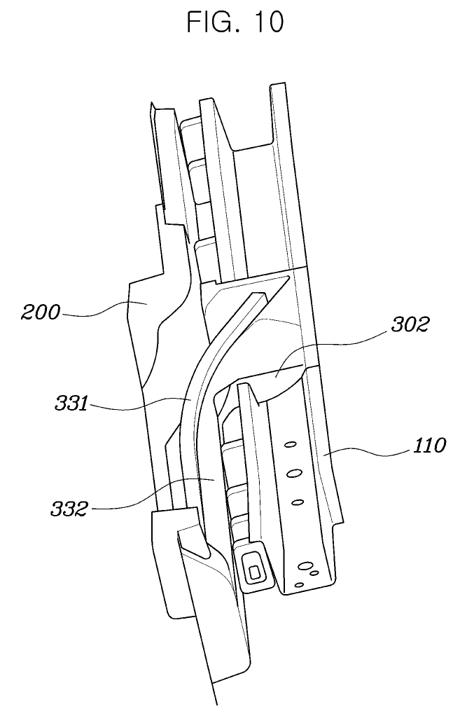

FIG. 1 is a lateral perspective view of a body of an example vehicle. FIG. 2 shows an enlarged view of a C-pillar region of a side sill in an example vehicle. FIG. 3 shows connections among the side sill, a support bracket, and a rear side member in an example vehicle. FIG. 4 is a bottom view of a portion of an example vehicle body. FIG. 5 is a lateral perspective view of the side sill and other components of an example vehicle. FIG. 6 shows an enlarged view of a B-pillar region of the side sill in an example vehicle. FIG. 7 shows a lateral cross-section taken along line A-A in FIG. 4. FIG. 8 shows a bottom portion of an example vehicle body. FIG. 9 shows the side sill, a door rail, and a center side member of an example vehicle. FIG. 10 shows the center side member of an example vehicle.

The vehicle body (e.g., frame) according to the present disclosure includes a rear wheel suspension device (also referred to as rear wheel suspension or rear suspension) 700 including a pair of trailing arms 710 and an axle beam configured to connect the trailing arms 710 in a width direction (e.g., lateral direction) of the vehicle, a rear side member (also referred to as rear side portion, rear side frame portion, or rear frame) 800 having one end connected to a center side member (also referred to as center side portion, center side frame portion, or center frame) 110 and the other end formed with a trailing arm connecting portion configured to receive each trailing arm 710 and to fasten the trailing arm 710 to the rear side member 800, a side sill 200 provided at side surfaces of the center side member 110 and the rear side member 800, and a support bracket 900 configured to connect an outer surface of the side sill 200 and an outer surface of the trailing arm, which connects a portion of the rear side member 800.

Specifically, the rear wheel suspension device 700 may be a coupled torsion beam axle (CTBA), and may be a non-independent rear wheel suspension system. The rear wheel suspension device 700 may connect the rear wheels of the vehicle to the vehicle body. The rear wheel suspension device 700 may include the pair of trailing arms 710 configured to control forward/rearward movement of the rear wheels. The pair of trailing arms 710 may be connected by an axle beam extending in the width direction (e.g., lateral direction) of the vehicle. The axle beam may be a beam configured to connect the left and right rear wheels by connecting the pair of trailing arms 710. The axle beam may allow a certain amount of torsion, enabling suspension operation.

Each trailing arm 710 may be connected to the rear side member 800. Specifically, one end of the rear side member 800 may be connected to an end of the center side member 110, which constitutes a center floor 100. The center side member 110 may have a bar shape extending in a longitudinal direction of the vehicle. The center side member 110 may be provided in a pair such that a pair of center side members 110 (e.g., a pair of center side frames) faces each other in the width direction of the vehicle. The pair of center side members 110 is connected to each other by a plurality of center cross members (also referred to as center cross portions or center cross beams) 120. That is, the pair of center side members 110 and the plurality of center cross members 120 are interconnected to provide basic rigidity to the vehicle body. The other end of each center side member 110 is connected to a front side member 400.

Referring to FIG. 3, the trailing arm connecting portion may be formed at the other end of the rear side member 800 to receive the trailing arm 710 and to couple the trailing arm 710 to the rear side member 800. To achieve a low floor height of the vehicle, that is, the purpose-built vehicle, a trailing arm connecting portion 810 may be formed at the other end of the rear side member 800 such that the trailing arm 710 may be inserted into an interior of the rear side member 800.

In some implementations, for coupling of an existing trailing arm 710 to the rear side member 800, a bushing protruding below a lower surface of the rear side member 800 may be formed. Due to this structure, a space may need to be provided beneath the rear side member 800. Due to provision of this space, there may be a limitation in achieving a low floor height of the vehicle.

In the present disclosure, a connection point between the trailing arm 710 and the rear side member 800 may be positioned higher as the trailing arm 710 is coupled to the rear side member 800 in a state of being inserted into the rear side member 800. As a result, a rotational center of the trailing arm 710 may be raised, allowing lower structural components to move upwards. As a result, the vehicle may have an additional (e.g., increased) interior space, which may, in turn, enable the vehicle body to be designed to have a lower floor height.

Furthermore, by having a lowered floor height, the center of gravity of the vehicle may be lowered, thereby enhancing driving stability. Additionally, the overall height of the vehicle may be lowered, thereby reducing air resistance. As a result, fuel efficiency and high-speed driving performance may be enhanced.

As shown in FIG. 3, if the trailing arm 710 is coupled to an inside of the rear side member 800, the cross-section of the other end of the rear side member 800 where the trailing arm 710 is coupled to the rear side member 800 may become locally weak. As a result, the rear collision performance may be negatively affected. To this end, a support bracket 900 may be introduced to connect the side sill 200, disposed at a side surface of the rear side member 800, to the other end of the rear side member 800, specifically, the trailing arm connecting portion 810.

More specifically, referring to FIG. 3, the support bracket 900 may be disposed between an outer surface of the railing arm fastening portion 810 of the trailing arm 710 inserted into the rear side member 800 and the side sill 200. The structure configured to insert the trailing arm 710 into the rear side member 800 is advantageous in terms of a low floor height. Due to this structure, however, the cross-sectional area of the trailing arm connecting portion 810 may be reduced. As a result, degradation of rigidity may occur. To compensate for this, the support bracket 900 may be needed to reinforce the trailing arm connecting portion 810 from the outside. The support bracket 900 connects the rear side member 800 to the side sill 200, dispersing a load and reducing stress concentrated on the rear side member 800.

Referring to FIG. 2, an open space is formed at an outer surface of the side sill 200. A connection bracket 210 may be further provided at the open space of the side sill 200. The connection bracket 210 may be connected to the support bracket 900 via the side sill 200. Although the connection bracket 210 is not directly connected to the support bracket 900, the connection bracket 210 may contribute to reinforcing the rigidity of the vehicle body in that the connection bracket 210 is indirectly connected to the support bracket 900 via the side sill 200.

That is, in addition to reinforcing the rear side member 800 and trailing arm connecting portion 810 by the support bracket 900, a multi-stage reinforcement structure may be applied in order to distribute a load, acting on the trailing arm connecting portion 810 of the trailing arm 710, to an inside of the side sill 200 and to effectively enhance the rigidity of the vehicle body.

The side sill 200, which is a lower side structure of the vehicle, may include an A-pillar region, a B-pillar region 220, and a C-pillar region 230. The A-pillar region, the B-pillar region 220, and the C-pillar region 230 may be sequentially disposed, in such an order, from the front of the vehicle to the back of the vehicle in the longitudinal direction of the vehicle. At the side surface of the side sill 200, the trailing arm connecting portion 810 of the rear side member 800 faces a rear end region of the side sill 200, specifically, the C-pillar region 230. In this state, the support bracket 900 connects the C-pillar region 230 and the trailing arm connecting portion 810 of the rear side member 800. In accordance with this configuration, it may be possible to effectively transmit and distribute the load, which acts on the trailing arm connecting portion 810 and the trailing arm 710 inserted into and coupled to the rear side member 800, to the C-pillar region 230 of the side sill 200. Consequently, it may be possible to enhance the structural rigidity of the trailing arm connecting portion 810.

Additionally, referring to FIGS. 4 and 8, a rear structure of the vehicle may further include a rear cross member 820 in addition to the rear side member 800. The rear cross member 820 may be configured to connect a pair of rear side members 800 in the width direction (e.g., lateral direction) of the vehicle to provide basic rigidity to the vehicle body. Additionally, a battery mounted to a lower portion of the vehicle may be coupled to the rear cross member (also referred to as rear cross portion or rear cross beam) 820. That is, both side surfaces of the battery may be coupled to the vehicle body via the center side members 110, respectively, in the longitudinal direction of the vehicle, whereas a rear end of the battery may be connected to the vehicle body via the rear cross member 820 in the width direction of the vehicle.

A sliding door, configured to be opened or closed in the longitudinal direction of the vehicle, may be mounted on the vehicle body. Referring to FIGS. 5 and 6, for application of the sliding door, a door rail 300 is provided. The door rail 300 is provided at an upper end of the side sill 200, and a sliding arm is coupled to the door rail 300 such that the sliding arm is slidable in the direction in which the door rail 300 extends. The sliding door is coupled to the sliding arm.

The door rail 300 may be formed at an upper surface of the side sill 200, but one end of the door rail 300 may be bent inwards toward the vehicle interior to be disposed inside the center side member 110. Since one end of the door rail 300 is disposed inside the vehicle, the sliding door 320 may be coplanar with an outer panel (e.g., a B-pillar, a C-pillar, etc.) of the vehicle body when the sliding door is closed. When the sliding door is opened, the sliding door may slide outwards beyond the outer panel, preventing interference with (e.g., coming in contact with, providing clearance from, etc.) other parts of the vehicle body.

As described above, the door rail 300 may be configured to enable the door arm 310 to slide in the longitudinal direction of the vehicle. The door rail 300 may include a lower rail support 332 formed at the upper surface of the side sill 200, and an upper rail guide 331 formed to face the lower rail support 332. The door arm 310 may be formed with a roller structure 311. The roller structure 311 is coupled to both the lower rail support 332 and the upper rail guide 331, to be slidable in the longitudinal direction of the vehicle.

The upper rail guide 331 may be formed at a lower surface of a door housing upper part (also referred to as upper door housing or upper plate of the door housing) 301. The door housing upper part 301 may serve to prevent the upper guide rail 331 and the lower rail support 332 from being exposed outwards. The door housing upper part 301 may function as an upper housing. Additionally, a door housing lower part (also referred to as lower door housing or lower plate of the door housing) 302 is provided at the center side member 110 to serve as a lower housing. Additionally, as shown in FIG. 6, the door housing upper part 301 is coplanar with a center plate covering upper surfaces of the center side member 110 and the center cross member 120 of the center floor 100.

Referring to FIGS. 9 and 10, the center side member 110 may have a shape in which an upper surface is opened and the other three surfaces are closed. However, an open portion 111 opened outwards may be formed at a side surface of a middle portion of the center side member 110. The door housing lower part 302 is inserted through the open portion 111, to allow the center side member 110 and the door housing lower part 302 to be coupled to each other. Since the door housing lower part 302 also has an open outer surface, one end of the door rail 300 is disposed inside the door housing lower part 302. One end of the door rail 300 may be considered to be disposed inside the center side member 110.

Since the connection bracket 210 provided at the side sill 200 is connected to the door rail 300 via the side sill 200, a load path, which transmits a load generated during a side collision of the vehicle to the door rail 300, may be additionally formed.

Additionally, referring to FIG. 5, the lower rail support 332 may be coupled to the upper surface of the side sill 200 to form a closed cross-section together with the upper surface of the side sill 200. The closed cross-section formed by the lower rail support 332 and the upper surface of the side sill 200 may extend from the C-pillar region 230 to the B-pillar region 220, thereby enhancing the rigidity of the vehicle body.

Referring to FIG. 3, the rear side member 800 may extend rearwards from one end thereof while gradually increasing in width, and the trailing arm connecting portion 810 may be formed at a width-increased portion of the rear side member 800. That is, the trailing arm connecting portion 810 may need to have a greater width than that of the one end of the rear side member 800 in order to enable the trailing arm 710 to be inserted into the rear side member 800. Further referring to FIG. 7, the rear side member 800 may further extend from the trailing arm connecting portion 810 while decreasing in width and, as such, a rear portion (also referred to as rear end) 830 of the rear side member 800 may be formed.

The rear portion 830 of the rear side member 800 may extend while being bent upwards from the trailing arm connecting portion 810. This structure may be required because the rear portion 830 of the rear side member 800 may need to be coupled to a damper 730 and a suspension 720, which constitute the rear wheel suspension device 700.

In accordance with the present disclosure, the above and other aspects may be accomplished by the provision of a body of a vehicle including a rear wheel suspension device including a pair of trailing arms and an axle beam configured to connect the trailing arms in a width direction of the vehicle, a rear side member having one end connected to a center side member and another end configured to fasten each trailing arm to the rear side member, a side sill provided at side surfaces of the center side member and the rear side member, and a support bracket configured to connect the side sill and a trailing arm connecting portion of the rear side member.

An outer surface of the side sill may be opened to form an open space. A connection bracket may be provided at the open space of the side sill. The connection bracket may be connected to the support bracket via the side sill.

The side sill may include a B-pillar region and a C-pillar region. The support bracket may connect the C-pillar region of the side sill and the trailing arm connecting portion of the rear side member.

The rear side member may be provided in a pair such that a pair of rear side members is spaced apart from each other in the width direction of the vehicle. The body may further include a rear cross member extending in the width direction of the vehicle and configured to connect the rear side members.

A battery may be coupled to the rear cross member in the width direction of the vehicle.

The body may further include a door rail provided at an upper end of the side sill, and a sliding arm, to which a sliding door is coupled, may be slidably coupled to the door rail.

One end of the door rail may be disposed inside the center side member.

The door rail may include a lower rail support formed at an upper surface of the side sill, a door housing upper part formed, at a lower portion thereof, with an upper rail guide such that the upper rail guide faces the lower rail support, and a door housing lower part provided at the center side member.

The lower rail support may form a closed cross-section together with the upper surface of the side sill.

The center side member may be shaped to have an open upper surface. An open portion opened outwards may be formed at a side surface of a middle portion of the center side member. The door housing lower part may be inserted through the open portion of the center side member and may be coupled to the center side member.

The body may further include a center floor including the center side member, a center cross member, and a center plate provided at upper surfaces of the center side member and the center cross member. The door housing upper part may be coplanar with the center plate.

One end of the lower rail support and one end of the upper rail guide may be disposed inside the door housing lower part.

The rear side member may extend from the one end thereof while gradually increasing in width, to form the trailing arm connecting portion, and may further extend from the trailing arm connecting portion while decreasing in width, to form a rear portion.

The rear portion may extend while being bent upwards from the trailing arm connecting portion.

The rear wheel suspension device may further include a damper and a suspension. The damper and the suspension may be coupled to the rear portion of the rear side member.

According to the vehicle body of the present disclosure, it is possible to ensure rear collision performance of a purpose-built vehicle in which a low floor height is implemented.

Effects attainable in the present disclosure are not limited to the above-described effects, and other effects of the present disclosure not yet described will be more clearly understood by those skilled in the art from the above description.

Although one or more example embodiments of the present disclosure have been disclosed for illustrative purposes, those skilled in the art will appreciate that various modifications, additions, and substitutions are possible, without departing from the scope and spirit of the disclosure as disclosed in the accompanying claims.

What is claimed is:

1. A vehicle body of a vehicle, the vehicle body comprising:
a rear suspension comprising:
a pair of trailing arms, and
an axle beam connecting, in a lateral direction of the vehicle, the trailing arms;
a rear side portion having a first end connected to a center side portion of the vehicle body and a second end connected to one of the pair of trailing arms;
a side sill provided on side surfaces of the center side portion and the rear side portion; and
a support bracket connecting the side sill to the second end of the rear side portion.

2. The vehicle body of claim 1, wherein an outer surface of the side sill is opened to form an open space,
wherein the vehicle body further comprises a connection bracket provided at the open space of the side sill and connected, via the side sill, to the support bracket.

3. The vehicle body of claim 2, wherein:
the side sill comprises a B-pillar region and a C-pillar region, and
the support bracket connects the C-pillar region of the side sill to the second end of the rear side portion.

4. The vehicle body of claim 1, wherein the rear side portion comprises a pair of rear side portions that are spaced apart from each other in the lateral direction of the vehicle, and
wherein the vehicle body further comprises:
a rear cross portion extending in the lateral direction of the vehicle and configured to connect the pair of rear side portions.

5. The vehicle body of claim 4, wherein a battery is coupled to the rear cross portion in the lateral direction of the vehicle.

6. The vehicle body of claim 2, further comprising:
a door rail provided at an upper end of the side sill;
a sliding arm slidably coupled to the door rail; and
a sliding door coupled to the sliding arm.

7. The vehicle body of claim 6, wherein a first end of the door rail is disposed inside the center side portion.

8. The vehicle body of claim 6, wherein the door rail comprises:
a lower rail support formed on an upper surface of the side sill; and
a door housing comprising:
an upper door housing, wherein an upper rail guide, which faces the lower rail support, is formed in a lower portion of the upper door housing; and
a lower door housing provided at the center side portion.

9. The vehicle body of claim 8, wherein the lower rail support forms, with the upper surface of the side sill, a closed cross-section.

10. The vehicle body of claim 8, wherein the center side portion is shaped to have an open upper surface,
wherein an open portion that is opened outwards is formed on a side surface of a middle portion of the center side portion, and
wherein the lower door housing is coupled to the center side portion by inserting through the open portion of the center side portion.

11. The vehicle body of claim 8, further comprising:
a center floor comprising the center side portion, a center cross portion, and a center plate,
wherein the center plate is provided on upper surfaces of the center side portion and the center cross portion, and
wherein the upper door housing is coplanar with the center plate.

12. The vehicle body of claim 10, wherein a first end of the lower rail support and a first end of the upper rail guide are disposed inside the lower door housing.

13. The vehicle body of claim 1, wherein the rear side portion increases in width as the rear side portion extends from the first end of the rear side portion to the second end of the rear side portion, and wherein the rear side portion decreases in width as the rear side portion further extends from the second end of the rear side portion to a third end of the rear side portion.

14. The vehicle body of claim 13, wherein the rear side portion bends upwards as the rear side portion extends from the second end of the rear side portion to the third end of the rear side portion.

15. The vehicle body of claim 14, wherein the rear suspension further comprises a damper and a suspension, and
wherein the damper and the suspension are coupled to the third end of the rear side portion.

16. A vehicle body of a vehicle, the vehicle body comprising:
a center frame;
a rear frame comprising:
a front portion connected to the center frame,
a middle portion connected to a rear suspension trailing arm of the vehicle, and
a rear portion;
a side sill provided along the center frame and the rear frame; and
a support bracket connecting the side sill to the middle portion of the rear frame.

17. The vehicle body of claim 16, further comprising:
a door rail support provided on the side sill; and
a door housing comprising a door rail guide, wherein the door rail guide is disposed to face the door rail support.

18. The vehicle body of claim 16, further comprising:
a floor comprising the center frame, a center cross beam, and a center plate.

19. The vehicle body of claim 16, wherein the rear frame increases in width as the rear frame extends from the front portion to the middle portion and decreases in width as the rear frame extends from the middle portion to the rear portion.

20. The vehicle body of claim 16, wherein the rear frame bends upward as the rear frame extends from the middle portion to the rear portion.
